(19) United States
(12) Patent Application Publication
(10) Pub. No.: US 2023/0018149 A1
(43) Pub. Date: Jan. 19, 2023

(54) SYSTEMS AND METHODS FOR CODE GENERATION FOR A PLURALITY OF ARCHITECTURES

(71) Applicant: Intel Corporation, Santa Clara, CA (US)

(72) Inventors: Mingqiu Sun, Beaverton, OR (US); Rajesh Poornachandran, Portland, OR (US); Vincent Zimmer, Issaquah, WA (US); Gopinatth Selvaraje, Portland, OR (US)

(73) Assignee: Intel Corporation, Santa Clara, CA (US)

(21) Appl. No.: 17/950,773

(22) Filed: Sep. 22, 2022

(51) Int. Cl. G06F 8/41; G06F 8/76

(52) U.S. Cl. CPC G06F 8/47; G06F 8/76

(57) ABSTRACT

Systems and methods for code generation for a plurality of architectures. At a host architecture, a JIT compile operation is performed for a received JavaScript or Web Assembly file. The JIT compiler references a host library that has been updated to include at least one new JIT instruction. Output from the JIT compile operation is compiled machine code for the host architecture that has new opcodes (OPX) added, responsive to the new JIT instruction. The JIT compiler executes the opcodes (OPX) in XuCode mode, meaning that the host architecture switches into a hardware protected private ISA (Instruction Set Architecture) called XuCode to implement the new JIT opcode instruction in XuCode.

### FIELD OF THE SPECIFICATION

This disclosure relates in general to the field of software compilation, and more particularly, though not exclusively, to systems and methods for code generation for a plurality of architectures.

### BACKGROUND

Software compilation or code generation refers to a translation of a software language into a native machine code that is specifically optimized for an architecture of the host machine. Various software languages have to be translated by the host. For example, JavaScript and WebAssembly languages are independent of host architecture and require software compilation by the host. The software compilation of JavaScript and WebAssembly generally references a host-specific library and is performed as a just-in-time (JIT) compilation operation. Continued improvements to the JIT code generation and software libraries are desirable.

### BRIEF DESCRIPTION OF THE DRAWINGS

The present disclosure is best understood from the following detailed description when read with the accompanying figures.

FIG. 1 is a simplified illustration of an operating environment that includes a host in communication with a browser, in accordance with various embodiments.

FIG. 2 is a flowchart for an example method for code generation for a plurality of architectures.

FIG. 3 illustrates examples of configurations of Web Assembly runtime environments and respective Web Assembly System Interfaces.

FIG. 4 is a block diagram of an example compute node that may include any of the embodiments disclosed herein.

FIG. 5 illustrates a multi-processor environment in which embodiments may be implemented.

FIG. 6 is a block diagram of an example processor to execute computer-executable instructions as part of implementing technologies described herein

### DETAILED DESCRIPTION

Increased Web usage has led to increasingly sophisticated and software-demanding Web applications. This increased demand has highlighted deficiencies in the efficiency of JavaScript, the current software language for Web applications. WebAssembly (also sometimes referred to as Wasm or WASM) is a collaboratively developed portable low-level bytecode designed to improve upon the deficiencies of JavaScript. WebAssembly is architecture independent (i.e., it is language-independent, hardware-independent, and platform-independent), and suitable for both Web use cases and non-Web use cases. WebAssembly computation is based on a stack machine with an implicit operand stack.

Because of the architecture-independence of JavaScript and WebAssembly, in practice, a host receiving a JavaScript file or WebAssembly program may employ a respective just-in-time (JIT) compilation module to translate or JIT software compile the JavaScript file or WebAssembly program into native machine code that is specifically optimized for the host architecture (e.g., a host processing unit, such as, a complex instruction set computer, “CISC,” that has a specific machine architecture and language). Often, the JIT compile operations are done in host software using host-specific libraries.

In various embodiments, the JIT compilation module may be called a browser, chrome browser, chrome V8 browser, JavaScript engine, just in time (JIT) compiler, or similar. In a non-limiting example, a Chrome browser sees a javascript.jsp file or Wasm file from web and calls a chrome V8 Library to do the JIT compilation. Currently JIT compiling (“jitting”) is done instruction by instruction.

The software environment in which jitting is done is called a runtime or runtime environment. The Wasm jitting is performed in a Wasm runtime environment. The jitting is often performed instruction by instruction, therefore, efficiently jitting the javascript.jsp file or WebAssembly code would mandate a good match between a Wasm runtime intermediate representation (WASM_IR) of received JavaScript or WebAssembly instructions and the hardware instruction set (native machine code) of the processing unit. Ideally, mapping between these two would be 1:1. However, some processing units or architectures do not have 1:1 mapping of JavaScript or WebAssembly instructions to the native machine code. For example, the WebAssembly swizzle and fmin/fmax instructions do not have 1:1 mapping to the Intel Architecture (IA) instructions, which means that a JIT for one of those instructions would require using multiple IA instructions.

Provided embodiments propose a technical solution for the above-described inefficiencies in the form of systems and methods for code generation for a plurality of architectures. Furthermore, other desirable features and characteristics of the system and method will become apparent from the subsequent detailed description and the appended claims, taken in conjunction with the accompanying drawings and the preceding background.

The terms “module,” “functional block,” “block,” “system,” and “engine” may be used herein, with functionality attributed to them. As one with skill in the art will appreciate, in various embodiments, the functionality of each of the module/blocks/systems/engines described herein can individually or collectively be achieved in various ways; such as, via an algorithm implemented in software and executed by a processor (e.g., a CPU, complex instruction set computer (CISC) device, a reduced instruction set device (RISC)), a compute node, a graphics processing unit (GPU)), a processing system, as discrete logic or circuitry, as an application specific integrated circuit, as a field programmable gate array, etc., or a combination thereof. The approaches and methodologies presented herein can be utilized in various computer-based environments (including, but not limited to, virtual machines, web servers, and stand-alone computers), edge computing environments, network environments, and/or database system environments.

As used herein, the terms “operating”, “executing”, or “running” as they pertain to software or firmware in relation to a processing unit, compute node, system, device, platform, or resource, are used interchangeably and can refer to software or firmware stored in one or more computer-readable storage media accessible by the system, device, platform or resource, even though the software or firmware instructions are not actively being executed by the system, device, platform, or resource.

As used herein, the term “circuitry” can comprise, singly or in any combination, non-programmable (hardwired) circuitry, programmable circuitry such as processors, state machine circuitry, and/or firmware that stores instructions executable by programmable circuitry.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. Elements described as “connected” may be in direct physical or electrical contact with each other, whereas elements described as “coupled” may co-operate or interact with each other, but they may or may not be in direct physical or electrical contact. Furthermore, the terms “comprising,” “including,” “having,” and the like, as used with respect to embodiments of the present disclosure, are synonymous. The drawings illustrate generally, by way of example, but not by way of limitation, various embodiments discussed in the present document.

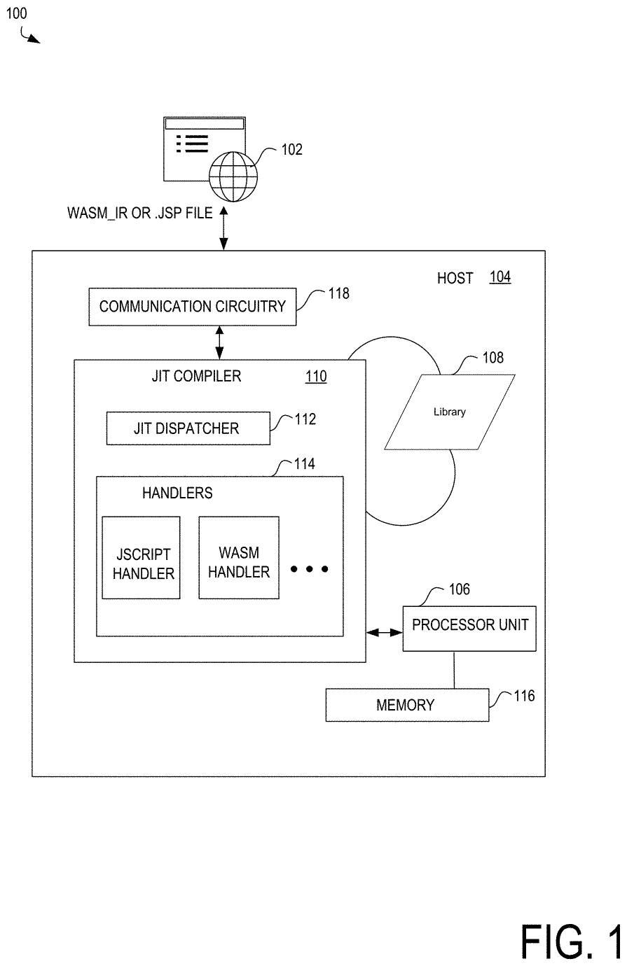

Turning now to FIG. 1, an operating environment 100 includes a simplified illustration of a host 104 apparatus configured to receive processor instructions, run a browser, and parse a web page. The host 104 is in operational communication via communication circuitry 118 with the source 102 of a JavaScript file or WASM_IR. The host 104, via the communication circuitry 118 perform CISC instruction monitoring.

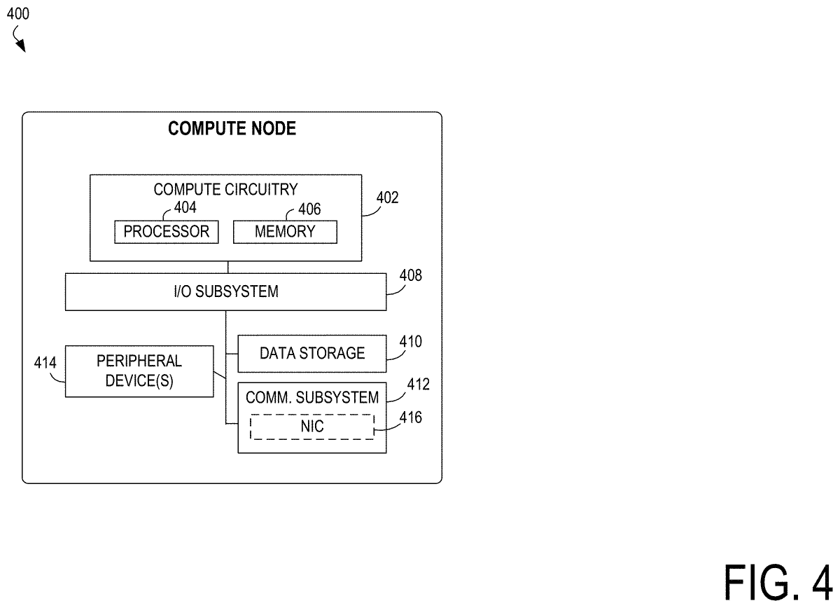

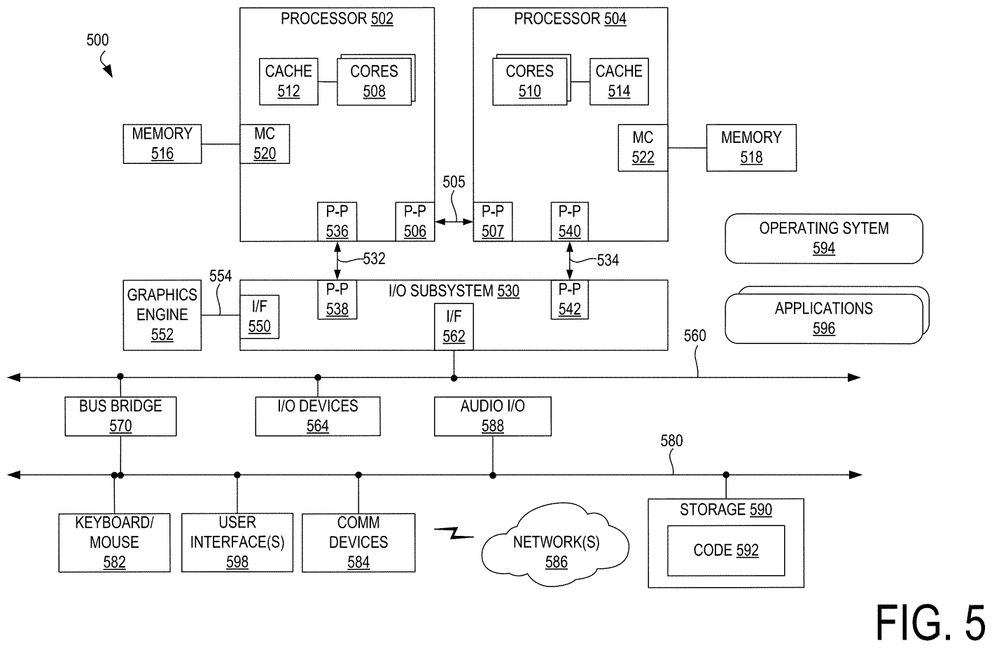

In practice, the source 102 may be one of a plurality of sources that each independently may transmit a JavaScript file or WASM_IR to the host 104. As described herein, the host 104 relies on at least one processor, indicated generally with processor 106, and together they embody a language and hardware architecture. The host 104 includes at least one storage unit, indicated generally with memory 116. As may be appreciated, in practice, the host 104 may be a complex computer node or computer processing system, and may include or be integrated with many more components and peripheral devices (see, for example, FIG. 4, compute node 400, and FIG. 5, computing system 500).

In a non-limiting example, the host 104 software comprises x86 instructions and the host 104 is configured to run a Chrome browser and perform x86 instruction monitoring. The host 104 apparatus or architecture includes or is upgraded to include new JIT compiler 110. The JIT compiler 110 can be realized as hardware (circuitry) or an algorithm or set of rules embodied in software (e.g., stored in the memory 116) and executed by the processor 106. The JIT compiler 110 manages JIT compile operations for the host 104, as described herein.

The JIT compiler 110 is depicted as a separate functional block or module for discussion; however, in practice, the JIT compiler 110 logic may be integrated with the host processor 106 as software, hardware, or a combination thereof. Accordingly, the JIT compiler 110 may be updated during updates to the host 104 software. The JIT compiler 110 (executed by the processor 106) executes a JIT compile operation, and in doing so, the JIT compiler 110 references the host library 108. Generally, the host specific library 108 may be considered a storage location (e.g., memory 116) preprogrammed or configured with microcode (also referred to as machine code) instructions that are native to the host 104 architecture, so that when the processor 106 performs a compile operation, the compile operation effectively translates incoming CISC instructions into native machine code.

Continuing with the example embodiment, the host operates in x86 instructions, is running a Chrome V8 browser, and references a Chrome V8 library 108. In various embodiments, the Chrome V8 library 108 is upgraded to include one or more new JIT instructions and respective opcodes. The new opcodes can give the end user optimization access into the JIT compilation. In an embodiment, the new JIT instruction has the form JIT_IT with respective opcodes (OPX) including <OP1><OP2><OP3><OP4>; the opcodes defined in Table 1, below.

TABLE 1

| Instruction | OP1 | OP2 | OP3 | OP4 |
|---|---|---|---|---|
| JIT_IT | Type of code, | Type of | Pointer to content (e.g., | Pointer to |
| | e.g., LLVM IR, | optimization, e.g., | a file) to retrieve and | buffer where |
| | Jscript, WASM | performance, power | JIT (e.g., a buffer with | compiled x86 |
| | | frugality | JavaScript, or. wasm | opcodes are |
| | | | content serialized into | stored |
| | | | memory) | |

For example, the JIT_IT opcode can be used to specify taking a Jscript and optimizing for performance, or taking a Wasm file and optimizing it for power frugality, etc.

To summarize the JIT compile operation performed by the JIT compiler 110: output from the JIT compile operation is compiled machine code for x86 that has new opcodes (OPX) added. The JIT compiler 110 is configured to respond to the new JIT instruction by executing the opcodes (OPX) in XuCode mode, meaning that the host processor 106 switches to use a hardware protected private ISA (Instruction Set Architecture) stored in a private system memory to implement the new JIT opcode instruction in XuCode. The protected private ISA called XuCode.

XuCode is a variant of 64-bit mode code on an x86 host machine that is stored in protected system memory and referenced therefrom during execution. XuCode has its own set of instructions. XuCode is a code sequence that can be an algorithm and/or can invoke another piece of hardware. It is authenticated and loaded as part of a microcode update. In various embodiments, the JIT compiler 110 adds a preamble to invoke XuCode execution and, after the processor (e.g., CISC CPU) completes execution in XuCode mode, the JIT compiler 110 adds a post-amble to resume x86 instruction monitoring by the host 104 of input from the source 102.

As mentioned, the JIT compiler 110 is configured to respond to the new JIT opcode by executing it in XuCode mode. In an embodiment, the JIT compiler 110 includes JIT dispatcher 112 logic that, responsive to the JIT_IT command, takes OP1 and calls a XuCode JIT handler 114, responsive to the OP1. The JIT dispatcher 112 can be a segment of machine code in the host 104. The XuCode JIT handler 114 can also be a segment of machine code in the host 104. The XuCode JIT handlers 114 (shortened herein to “handlers”) can be specific for the type of (OP1) code to optimize (wherein type includes JavaScript and WASM) and each handler 114 can be embodied as a microcode patch in XuCode. For example, in various embodiments, there may be a JavaScript XuCode JIT handler, a Wasm XuCode JIT handler, and so on. The XuCode JIT handler 114 coordinate XuCode execution, responsive to the determination of the OP1 type.

The host 104 can be updated during a boot or at runtime. For example, the library 108 can be updated and/or new handlers 114 can be loaded into the protected system memory couple to or integrated with the x86 CPU (e.g., processor 106, or FIG. 5, computing system 500) during boot or runtime. In various embodiments, the microcode patches comprising the handlers 114 can be licensed or restricted to certain processor types and monetized.

As is depicted in Table 1, non-limiting examples of the optimization access provided by the new JIT_IT instruction includes performance optimization and power frugality. In various scenarios, the performance and power information gathered using JIT_IT can be used to inform future optimization of the JIT compile operation. Advantageously, at the completion of jitting the WASM_IR or JavaScript, respective x86 opcodes have been efficiently generated, and various telemetry or performance and power data may have been collected.

In some embodiments, the host library 108 may include another new opcode “Destination ISA,” also executable in XuCode. This opcode will enable cross-compiling to a target CPU (processor) that is different from the host processor 106. As a non-limiting example, when this opcode is executed, the XuCode could JIT compile a Wasm file to a tenth generation ISA (GEN10 ISA) XPU, or to an ARM ISA; such output could be downloaded to a Mt. Evans ARM-based IPU (image processing unit), etc.

Additionally, in some embodiments, the library 108 may include a new opcode “JIT and Run,” also executable in XuCode. JIT and Run would enable the JIT code to run in XuCode's hidden memory space. In a variation of JIT and Run, a customer can use this opcode from a private memory, such as, trust domain (TD), trust domain extension (TDX), or software guard extension (SGX) to protect their content.

The functions and interactions of these system architectural blocks can be further described with a series of operations in a method. As used herein, a processor 106 (e.g., a CISC machine) or a computer device, a compute node (FIG. 4, 400) or a processing system (e.g., FIG. 5, 500) referred to as being programmed to perform a method can be programmed to perform the method via software, hardware, firmware or combinations thereof.

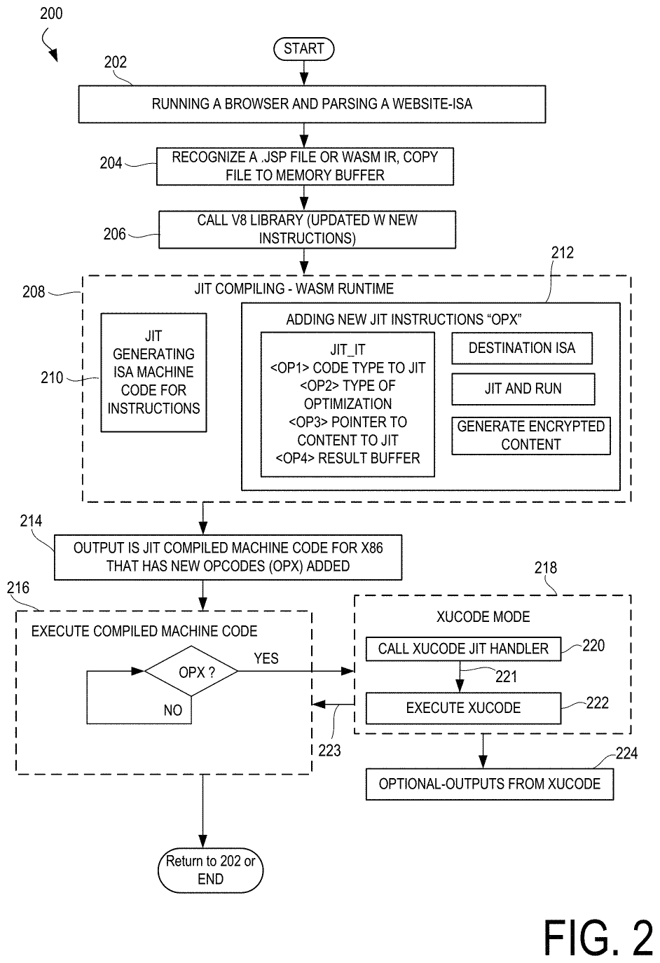

FIG. 2 provides an example method 200 for code generation for a plurality of architectures. For illustrative purposes, the following description of the method 200 may refer to elements mentioned above in connection with FIG. 1. In various embodiments, portions of method 200 may be performed by different components of the described system environment 100. It should be appreciated that method 200 may include any number of additional or alternative operations and tasks, the tasks shown in FIG. 2 need not be performed in the illustrated order, and method 200 may be incorporated into a more comprehensive procedure or method, such as a ride-sharing application, having additional functionality not described in detail herein. Moreover, one or more of the tasks shown in FIG. 2 could be omitted from an embodiment of the method 200 if the intended overall functionality remains intact.

At 202, the host 104 is running a browser and parsing a website. The host 104 is operating in its respective CISC architecture language. In an example, the host 104 is operating in x86 instructions. At 204, the host receives or recognizes a JavaScript (.jsp) file or a WASM_IR; to simplify this reference, these two program files may be collectively referred to as a “JIT file.” The host 104 may copy the JIT file into a memory buffer, such as, a buffer located in memory 116.

At 206, the host library 108 is referenced or called. In various embodiments, the JIT compiler 110 manages this library call. As mentioned herein, the host library 108 can be updated with a microcode patch at boot or during runtime.

At 208, the JIT compiling begins, wherein the instructions in the JIT file are JIT compiled into machine code for the host 104 architecture. Said differently, at 208, code generation for the host 104 architecture is performed. In an example, at 208, x86 instructions in the JIT file are compiled into machine code for the x86 instructions. Referring to FIG. 1, these operations may be managed by the JIT compiler 110 and host 104 processor 106. In various embodiments, compiling the JIT file may include a determination that a JIT instruction in the JIT file introduces one or more new opcodes (“OPx”). Moreover, in various embodiments, compiling the JIT file may include determining that a JIT instruction in the JIT file specifies specific opcodes OPx (OP1, OP2, OP3, OP4, etc., as described in Table 1).

The output 214 from operation 208 includes ISA machine code 210 for instructions in the JIT file, plus any additional opcodes 212 (OPx) for any new instructions that have been added to the host library 108 (such as, JIT_IT, described above).

The JIT compiler 110 can perform code generation at 208 for a plurality of different host architectures, as described above for the OPx “Destination ISA,” instruction.

As mentioned, the instructions are JIT compiled, and as they are generated, they may be promptly executed at 216 by the host 104. While executing the compiled machine code at 216, if an opcode is one of the new opcodes “OPx,” (the additional opcodes at 212), it is executed in XuCode mode 218 (e.g., by calling a respective XuCode JIT handler 114 at 220 and executing the XuCode at 222). In various embodiments, executing the XuCode may include placing a preamble (221) before the opcode or opcodes to be executed in XuCode mode and placing a post amble (223) after the opcode(s) to return to x86 execution after XuCode execution at 222 is completed. In some scenarios, at 224, such as when OPx is “JIT and Run,” the code generation from the JIT compiling at 208, upon execution in XuCode mode at 218, results in an output 224.

The JIT compiling at 208, the execution at 216, and the XuCode execution at 218, is managed by the JIT compiler 110, in coordination with the host processor 106.

Thus, systems and methods for code generation for a plurality of architectures have been described. Advantageously, provided embodiments enable the flexibility of jitting a chunk of instructions at the same time, as a whole (i.e., in parallel), without requiring a 1:1 mapping, which increases efficiency of the code generation or compilation. Additionally, by enabling the collection of performance and power metrics, the provided embodiments enable optimization in code development.

As mentioned, Wasm is a collaboratively developed portable low-level bytecode designed to improve upon the deficiencies of JavaScript. In various scenarios, Wasm was developed with a component model in which code is organized in modules that have a shared-nothing inter-component invocation. A host 104, such as a virtual machine, container, or microservice, can be populated with multiple different Wasm components (also referred to herein as Wasm modules). The Wasm modules interface using the shared-nothing interface, which enables fast instance-derived import calls. The shared-nothing interface enables software and hardware optimization via adaptors.

A Wasm module contains definitions for functions, globals, tables, and memories. The definitions can be imported or exported. A module can define only one memory, that memory is a traditional linear memory that is mutable and may be shared. The code in a module can be organized into functions. Functions can call each other, but functions cannot be nested. Instantiating a module can be provided by a JavaScript virtual machine or an operating system. An instance of a module corresponds to a dynamic representation of the module, its defined memory, and an execution stack. A Wasm computation is initiated by invoking a function exported from the instance.

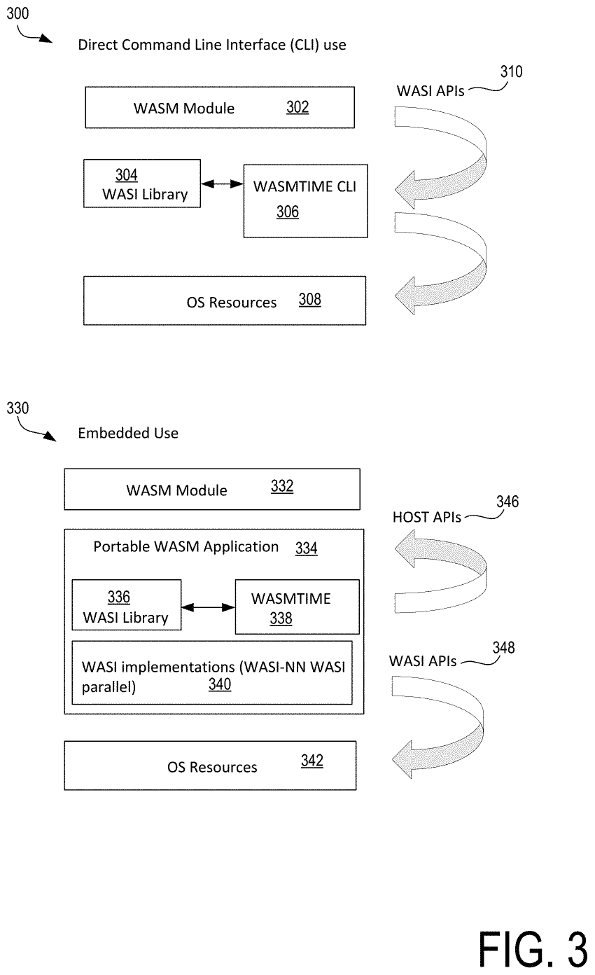

WASMTIME and WASI. WASMTIME is a jointly developed industry leading WebAssembly runtime; it includes a JIT compiler for Wasm written in Rust. In various embodiments, a Web Assembly System Interface (WASI) that may be host specific (processor specific) is used to enable application specific protocols (e.g., for machine language, for machine learning, etc.) for communication and data sharing between the software environment running Wasm (WASMTIME) and other host components. These concepts are illustrated in FIG. 3. Embodiment 300 illustrates a Wasm module 302 embodied as a direct command line interface (CLI). The WASI library 304 is referenced during WASMTIME CLI 306, and the operating system (OS) resources 308 of the host are utilized. A WASI application programming interface(s) 310 (“WASI API”) enables communication and data sharing between the components in embodiment 300.

Embodiment 330 illustrates a Wasm module 332 in which WASMTIME and WASI are embedded in an application. In the embedded environment, a portable Wasm application 334 includes the WASI library 336 that is referenced during WASMTIME 338. The portable Wasm application 334 may be referred to as a user application. Embodiment 330 may employ a host API 346 for communication and data sharing within the Wasm application 334 and employ multiple WASI implementations 340 for communication and data sharing between the portable Wasm application 334 and the host OS resources 342 (indicated generally with WASI APIs 348). In various embodiments, different instances of WASI may be concurrently supported for communications with a host application, a native OS, bare metal, a Web polyfill, or similar. The portable Wasm application 334 can transmit into the Wasm runtime environment 338 model and encoding information, and the Wasm runtime environment 338 may also reference models based thereon, such as, in a non-limiting example, a virtualized I/O machine learning (ML) model. Embodiment 330 may represent a standalone environment, such as, a standalone desktop, an Internet of Things (IOT) environment, a cloud application (e.g., a content delivery network (CDN), function as a service (FaaS), an envoy proxy, or the like). In other scenarios, embodiment 330 may represent a resource constrained environment, such as in IOT, embedding, or the like.

The systems and methods described herein can be implemented in or performed by any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment).

As used herein, the term “computing system” includes compute nodes, computing devices, and systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

In the simplified example depicted in FIG. 4, a compute node 400 includes a compute engine (referred to herein as “compute circuitry”) 402, an input/output (I/O) subsystem 408, data storage 410, a communication circuitry subsystem 412, and, optionally, one or more peripheral devices 414. With respect to the present example, the compute node 400 or compute circuitry 402 may perform the operations and tasks attributed to the host 104. In other examples, respective compute nodes 500 may include other or additional components, such as those typically found in a computer (e.g., a display, peripheral devices, etc.). Additionally, in some examples, one or more of the illustrative components may be incorporated in, or otherwise form a portion of, another component.

In some examples, the compute node 400 may be embodied as a single device such as an integrated circuit, an embedded system, a field-programmable gate array (FPGA), a system-on-a-chip (SOC), or other integrated system or device. In the illustrative example, the compute node 400 includes or is embodied as a processor 404 and a memory 406. The processor 404 may be embodied as any type of processor capable of performing the functions described herein (e.g., executing compile functions and executing an application). For example, the processor 404 may be embodied as a multi-core processor(s), a microcontroller, a processing unit, a specialized or special purpose processing unit, or other processor or processing/controlling circuit.

In some examples, the processor 404 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 404 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that a xPU, a SOC, a CPU, and other variations of the processor 404 may work in coordination with each other to execute many types of operations and instructions within and on behalf of the compute node 400.

The memory 406 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 406 may be integrated into the processor 404. The memory 406 may store various software and data used during operation such as one or more applications, data operated on by the application(s), libraries, and drivers.

The compute circuitry 402 is communicatively coupled to other components of the compute node 400 via the I/O subsystem 408, which may be embodied as circuitry and/or components to facilitate input/output operations with the compute circuitry 402 (e.g., with the processor 404 and/or the main memory 406) and other components of the compute circuitry 402. For example, the I/O subsystem 408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 408 may form a portion of a system-on-a-chip (SoC) and be incorporated, along with one or more of the processor 404, the memory 406, and other components of the compute circuitry 402, into the compute circuitry 402.

The one or more illustrative data storage devices 410 may be embodied as any type of devices configured for short-term or long-term storage of data such as, for example, memory devices and circuits, memory cards, hard disk drives, solid-state drives, or other data storage devices. Individual data storage devices 410 may include a system partition that stores data and firmware code for the data storage device 410. Individual data storage devices 410 may also include one or more operating system partitions that store data files and executables for operating systems depending on, for example, the type of compute node 400.

The communication circuitry 412 may be embodied as any communication circuit, device, transceiver circuit, or collection thereof, capable of enabling communications over a network between the compute circuitry 402 and another compute device (e.g., an edge gateway of an implementing edge computing system).

The communication subsystem 412 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication subsystem 412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication subsystem 412 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication subsystem 412 may operate in accordance with other wireless protocols in other embodiments. The electrical device 400 may include an antenna 422 to facilitate wireless communications and/or to receive other wireless communications (such as AM or FM radio transmissions).

In some embodiments, the communication subsystem 412 may manage wired communications, such as electrical, optical, or any other suitable communication protocols (e.g., IEEE 802.3 Ethernet standards). As noted above, the communication component 412 may include multiple communication components. For instance, a first communication subsystem 412 may be dedicated to shorter-range wireless communications such as Wi-Fi or Bluetooth, and a second communication subsystem 412 may be dedicated to longer-range wireless communications such as global positioning system (GPS), EDGE, GPRS, CDMA, WiMAX, LTE, EV-DO, or others. In some embodiments, a first communication subsystem 412 may be dedicated to wireless communications, and a second communication subsystem 412 may be dedicated to wired communications.

The illustrative communication subsystem 412 includes an optional network interface controller (NIC) 420, which may also be referred to as a host fabric interface (HFI). The NIC 420 may be embodied as one or more add-in-boards, daughter cards, network interface cards, controller chips, chipsets, or other devices that may be used by the compute node 400 to connect with another compute device (e.g., an edge gateway node). In some examples, the NIC 420 may be embodied as part of a system-on-a-chip (SoC) that includes one or more processors or included on a multichip package that also contains one or more processors. In some examples, the NIC 420 may include a local processor (not shown) and/or a local memory (not shown) that are both local to the NIC 420. In such examples, the local processor of the NIC 420 may be capable of performing one or more of the functions of the compute circuitry 402 described herein. Additionally, or alternatively, in such examples, the local memory of the NIC 420 may be integrated into one or more components of the client compute node at the board level, socket level, chip level, and/or other levels.

Additionally, in some examples, a respective compute node 400 may include one or more peripheral devices 414. Such peripheral devices 414 may include any type of peripheral device found in a compute device or server such as audio input devices, a display, other input/output devices, interface devices, and/or other peripheral devices, depending on the particular type of the compute node 400. In further examples, the compute node 400 may be embodied by a respective edge compute node (whether a client, gateway, or aggregation node) in an edge computing system or like forms of appliances, computers, subsystems, circuitry, or other components.

In other examples, the compute node 400 may be embodied as any type of device or collection of devices capable of performing various compute functions. Respective compute nodes 400 may be embodied as a type of device, appliance, computer, or other “thing” capable of communicating with other compute nodes that may be edge, networking, or endpoint components. For example, a compute device may be embodied as a personal computer, server, smartphone, a mobile compute device, a smart appliance, smart camera, an in-vehicle compute system (e.g., a navigation system), a weatherproof or weather-sealed computing appliance, a self-contained device within an outer case, shell, etc., or other device or system capable of performing the described functions.

FIG. 5 illustrates a multi-processor environment in which embodiments may be implemented. Processors 502 and 504 further comprise cache memories 512 and 514, respectively. The cache memories 512 and 514 can store data (e.g., instructions) utilized by one or more components of the processors 502 and 504, such as the processor cores 508 and 510. The cache memories 512 and 514 can be part of a memory hierarchy for the computing system 500. For example, the cache memories 512 can locally store data that is also stored in a memory 516 to allow for faster access to the data by the processor 502. In some embodiments, the cache memories 512 and 514 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor or among multiple processors in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 500 is shown with two processors, the computing system 500 can comprise any number of processors. Further, a processor can comprise any number of processor cores. A processor can take various forms such as a central processing unit (CPU), a graphics processing unit (GPU), general-purpose GPU (GPGPU), accelerated processing unit (APU), field-programmable gate array (FPGA), neural network processing unit (NPU), data processor (DPU), accelerator (e.g., graphics accelerator, digital signal processor (DSP), compression accelerator, artificial intelligence (AI) accelerator), controller, or other types of processing units. As such, the processor can be referred to as an XPU (or xPU). Further, a processor can comprise one or more of these various types of processing units. In some embodiments, the computing system comprises one processor with multiple cores, and in other embodiments, the computing system comprises a single processor with a single core. As used herein, the terms “processor,” “processor unit,” and “processing unit” can refer to any processor, processor core, component, module, engine, circuitry, or any other processing element described or referenced herein.

In some embodiments, the computing system 500 can comprise one or more processors that are heterogeneous or asymmetric to another processor in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processors in a system.

The processors 502 and 504 can be located in a single integrated circuit component (such as a multi-chip package (MCP) or multi-chip module (MCM)) or they can be located in separate integrated circuit components. An integrated circuit component comprising one or more processors can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor, or on one or more integrated circuit dies separate from the integrated circuit dies comprising the processors. In some embodiments, these separate integrated circuit dies can be referred to as “chiplets”. In some embodiments where there is heterogeneity or asymmetry among processors in a computing system, the heterogeneity or asymmetric can be among processors located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processors 502 and 504 further comprise memory controller logic (MC) 520 and 522. As shown in FIG. 5, MCs 520 and 622 control memories 516 and 518 coupled to the processors 502 and 504, respectively. The memories 516 and 518 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 520 and 522 are illustrated as being integrated into the processors 502 and 504, in alternative embodiments, the MCs can be external to a processor.

Processors 502 and 504 are coupled to an Input/Output (I/O) subsystem 530 via point-to-point interconnections 532 and 534. The point-to-point interconnection 532 connects a point-to-point interface 536 of the processor 502 with a point-to-point interface 538 of the I/O subsystem 530, and the point-to-point interconnection 534 connects a point-to-point interface 540 of the processor 504 with a point-to-point interface 542 of the I/O subsystem 530. Input/Output subsystem 530 further includes an interface 550 to couple the I/O subsystem 530 to a graphics engine 552. The I/O subsystem 530 and the graphics engine 552 are coupled via a bus 554.

The Input/Output subsystem 530 is further coupled to a first bus 560 via an interface 562. The first bus 560 can be a Peripheral Component Interconnect Express (PCIe) bus or any other type of bus. Various I/O devices 564 can be coupled to the first bus 560. A bus bridge 570 can couple the first bus 560 to a second bus 580. In some embodiments, the second bus 580 can be a low pin count (LPC) bus. Various devices can be coupled to the second bus 580 including, for example, a keyboard/mouse 582, audio I/O devices 588, and a storage device 590, such as a hard disk drive, solid-state drive, or another storage device for storing computer-executable instructions (code) 592 or data. The code 592 can comprise computer-executable instructions for performing methods described herein. Additional components that can be coupled to the second bus 580 include communication device(s) 584, which can provide for communication between the computing system 500 and one or more wired or wireless networks 586 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

In embodiments where the communication devices 584 support wireless communication, the communication devices 584 can comprise wireless communication components coupled to one or more antennas to support communication between the computing system 500 and external devices. The wireless communication components can support various wireless communication protocols and technologies such as Near Field Communication (NFC), IEEE 802.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 500 can comprise removable memory such as flash memory cards (e.g., SD (Secure Digital) cards), memory sticks, Subscriber Identity Module (SIM) cards). The memory in system 500 (including caches 512 and 514, memories 516 and 518, and storage device 590) can store data and/or computer-executable instructions for executing an operating system 594 and application programs 596. Example data includes web pages, text messages, images, sound files, and video data biometric thresholds for particular users or other data sets to be sent to and/or received from one or more network servers or other devices by the system 500 via the one or more wired or wireless networks 586, or for use by the system 500. The system 500 can also have access to external memory or storage (not shown) such as external hard drives or cloud-based storage.

The operating system 594 (also simplified to “OS” herein) can control the allocation and usage of the components illustrated in FIG. 5 and support the one or more application programs 596. The application programs 596 can include common computing system applications (e.g., email applications, calendars, contact managers, web browsers, messaging applications) as well as other computing applications.

In some embodiments, a hypervisor (or virtual machine manager) operates on the operating system 594 and the application programs 596 operate within one or more virtual machines operating on the hypervisor. In these embodiments, the hypervisor is a type-2 or hosted hypervisor as it is running on the operating system 594. In other hypervisor-based embodiments, the hypervisor is a type-1 or “bare-metal” hypervisor that runs directly on the platform resources of the computing system 594 without an intervening operating system layer.

In some embodiments, the applications 596 can operate within one or more containers. A container is a running instance of a container image, which is a package of binary images for one or more of the applications 596 and any libraries, configuration settings, and any other information that one or more applications 596 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 594. An orchestrator can be responsible for management of the computing system 500 and various container-related tasks such as deploying container images to the computing system 594, monitoring the performance of deployed containers, and monitoring the utilization of the resources of the computing system 594.

The computing system 500 can support various additional input devices, represented generally as user interfaces 598, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 500. External input and output devices can communicate with the system 500 via wired or wireless connections.

In addition, one or more of the user interfaces 598 may be natural user interfaces (NUIs). For example, the operating system 594 or applications 596 can comprise speech recognition logic as part of a voice user interface that allows a user to operate the system 500 via voice commands. Further, the computing system 500 can comprise input devices and logic that allows a user to interact with computing the system 500 via body, hand or face gestures. For example, a user's hand gestures can be detected and interpreted to provide input to a gaming application.

The I/O devices 564 can include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 500 can further comprise one or more additional antennas coupled to one or more additional receivers, transmitters, and/or transceivers to enable additional functions.

In addition to those already discussed, integrated circuit components, integrated circuit constituent components, and other components in the computing system 594 can communicate with interconnect technologies such as Intel® QuickPath Interconnect (QPI), Intel® Ultra Path Interconnect (UPI), Computer Express Link (CXL), cache coherent interconnect for accelerators (CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 694 may utilize more or more interconnect technologies.

It is to be understood that FIG. 5 illustrates only one example computing system architecture. Computing systems based on alternative architectures can be used to implement technologies described herein. For example, instead of the processors 502 and 504 and the graphics engine 552 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 5. Moreover, the illustrated components in FIG. 5 are not required or all-inclusive, as shown components can be removed and other components added in alternative embodiments.

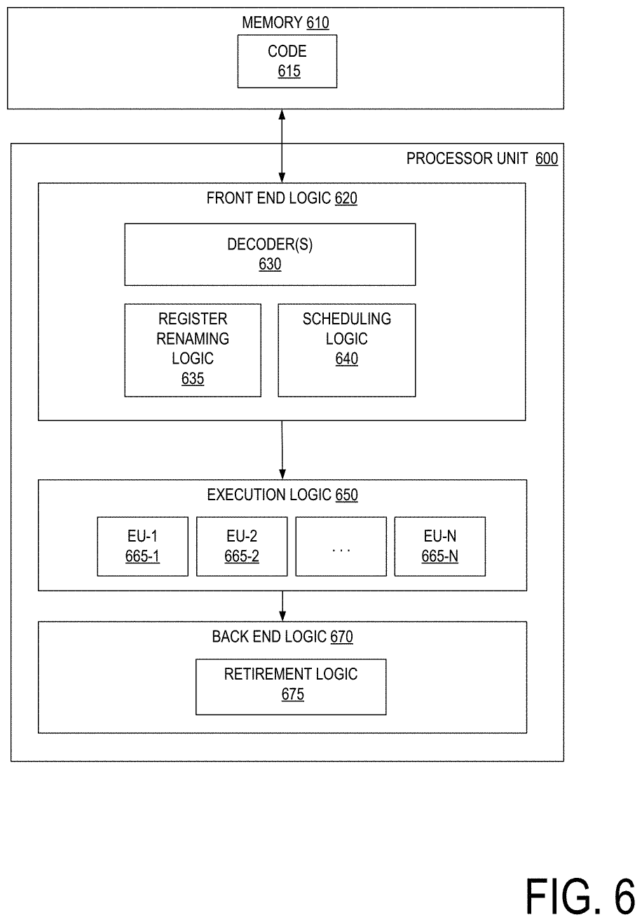

FIG. 6 is a block diagram of an example processor 600 to execute computer-executable instructions as part of implementing technologies described herein. The processor 600 can be a single-threaded core or a multithreaded core in that it may include more than one hardware thread context (or “logical processor”) per processor.

FIG. 6 also illustrates a memory 610 coupled to the processor 600. The memory 610 can be any memory described herein or any other memory known to those of skill in the art. The memory 610 can store computer-executable instructions 615 (code) executable by the processor 600.

The processor comprises front-end logic 620 that receives instructions from the memory 610. An instruction can be processed by one or more decoders 630. The decoder 630 can generate as its output a micro-operation such as a fixed width micro-operation in a predefined format, or generate other instructions, microinstructions, or control signals, which reflect the original code instruction. The front-end logic 620 further comprises register renaming logic 635 and scheduling logic 640, which generally allocate resources and queues operations corresponding to converting an instruction for execution.

The processor 600 further comprises execution logic 650, which comprises one or more execution units (EUs) 665-1 through 665-N. Some processor embodiments can include a few execution units dedicated to specific functions or sets of functions. Other embodiments can include only one execution unit or one execution unit that can perform a particular function. The execution logic 650 performs the operations specified by code instructions. After completion of execution of the operations specified by the code instructions, back-end logic 670 retires instructions using retirement logic 675. In some embodiments, the processor 600 allows out of order execution but requires in-order retirement of instructions. Retirement logic 675 can take a variety of forms as known to those of skill in the art (e.g., re-order buffers or the like).

The processor 600 is transformed during execution of instructions, at least in terms of the output generated by the decoder 630, hardware registers and tables utilized by the register renaming logic 635, and any registers (not shown) modified by the execution logic 650.

Any of the disclosed methods (or a portion thereof) can be implemented as computer-executable instructions (also referred to as machine readable instructions) or a computer program product stored on a computer readable (machine readable) storage medium. Such instructions can cause a computing system or one or more processors capable of executing computer-executable instructions to perform any of the disclosed methods.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the host or computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, Web Assembly, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but it is not necessary that every embodiment include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The following examples pertain to additional embodiments of technologies disclosed herein.

Example 1 is an apparatus, comprising: a processor; a protected system memory; a just in time (JIT) compiler executable by the processor to: receive a JIT file comprising instructions; JIT compile the JIT file into machine code, wherein the machine code includes a translation for the instructions in the JIT file, plus an opcode for a JIT instruction; and use code stored in the protected system memory to execute the opcode for the JIT instruction while executing the machine code.

Example 2 includes the subject matter of Example 1, wherein the JIT file is a JavaScript file.

Example 3 includes the subject matter of Example 1, wherein the JIT file is a Web Assembly file.

Example 4 includes the subject matter of any one of Examples 1-3, wherein the JIT instruction is JIT_IT.

Example 5 includes the subject matter of any one of Examples 1-3, wherein the JIT instruction specifies, in a first opcode location (OP1), a file type, the file type including JavaScript files and Web Assembly files.

Example 6 includes the subject matter of any one of Examples 1-5, wherein the JIT instruction specifies, in a second opcode location (OP2), a type of optimization, wherein the type of optimization includes performance optimization and power frugality.

Example 7 includes the subject matter of any one of Examples 1-6, further comprising a memory component having content to compile stored at a memory location, and wherein the JIT instruction, in a third location (OP3), includes a pointer to the memory location.

Example 8 includes the subject matter of any one of Examples 1-7, further comprising a memory component, and wherein the JIT instruction, in a fourth location (OP4), includes a pointer to a location in the memory component to store the machine code.

Example 9 includes the subject matter of any one of Examples 1-8, wherein the apparatus comprises a virtual machine, container, or microservice.

Example 10 includes the subject matter of any one of Examples 1-9, wherein executing the opcode comprises executing in XuCode mode.

Example 11 includes the subject matter of any one of Examples 1-10, wherein executing the opcode in the protected system memory comprises inserting a preamble before the opcode and inserting a post amble after the opcode.

Example 12 includes the subject matter of any one of Examples 1 or 6-11, wherein the JIT instruction specifies, in a first opcode location (OP1), a file type, the file type including JavaScript files and Web Assembly files, and further comprising: JIT dispatcher logic to call a XuCode JIT handler for the OP1, responsive to receiving the JIT instruction.

Example 13 includes the subject matter of Example 12, wherein the XuCode JIT handler comprises a microcode patch, and the JIT compiler is further to update the XuCode JIT handler during a boot.

Example 14 is a method comprising: at a processor, executing a just in time (JIT) compiler; updating a library to include a JIT instruction; receiving a JIT file from an external source, the JIT file comprising instructions; JIT compiling the JIT file into machine code for the processor, wherein the machine code includes a translation for the instructions in the JIT file, plus an opcode for the JIT instruction; and executing the opcode using code stored in a protected system memory while executing the machine code.

Example 15 includes the subject matter of Example 14, further comprising determining that the JIT instruction specifies, in a first opcode location (OP1), a file type, the file type including JavaScript files and Web Assembly files.

Example 16 includes the subject matter of Example 14, further comprising determining that the JIT instruction specifies, in a second opcode location (OP2), a type of optimization, wherein the type of optimization includes performance optimization and power frugality.

Example 17 includes the subject matter of Example 14, further comprising determining that the JIT instruction specifies, in a third location (OP3), a pointer to a memory location to retrieve the JIT file.

Example 18 includes the subject matter of Example 14, further comprising determining that the JIT instruction specifies, in a fourth location (OP4), a pointer to a memory location to store the machine code.

Example 19 includes the subject matter of Example 14, further comprising executing the opcode in XuCode mode.

Example 20 includes the subject matter of Example 14, wherein executing the opcode comprises inserting a preamble before the opcode and inserting a post amble after the opcode.

Example 21 includes the subject matter of Example 14, further comprising utilizing a microcode patch referred to as a JIT dispatcher for a determination that the JIT instruction specifies, in a first opcode location (OP1), a file type, the file type including JavaScript files and Web Assembly files; and utilizing a microcode patch referred to as a handler for the OP1, to coordinate XuCode execution, responsive to the determination.

Example 22 includes the subject matter of Example 21, further comprising updating the JIT dispatcher, the library, and the handler during a boot.

Example 23 includes the subject matter of any one of Examples 14-22, wherein the processor is within a host architecture, and the host architecture comprises a virtual machine, container, or microservice.

Example 24 is one or more machine readable storage media having instructions stored thereon, the instructions when executed by a machine are to cause the machine to: update a library in an apparatus to include a just in time (JIT) instruction; receive a JIT file from a web browser, the JIT file comprising instructions; JIT compile the JIT file into machine code for the apparatus, wherein the machine code includes a translation for the instructions in the JIT file, plus an opcode for the JIT instruction; and execute the opcode for the JIT instruction using instructions stored in a protected system memory while executing the machine code.

Example 25 includes the subject matter of Example 24, wherein the instructions, when executed by the machine, are to cause the machine further to determine that the JIT instruction specifies, in a first opcode location (OP1), a file type, the file type including JavaScript files and Web Assembly files.

Example 26 includes the subject matter of Example 24, wherein the instructions, when executed by the machine, are to cause the machine further to determine that the JIT instruction specifies, in a second opcode location (OP2), a type of optimization, wherein the type of optimization includes performance optimization and power frugality.

Example 27 includes the subject matter of Example 24, wherein the instructions, when executed by the machine, are to cause the machine further to determine that the JIT instruction specifies, in a third location (OP3), a pointer to a memory location to retrieve the JIT file.

Example 28 includes the subject matter of Example 24, wherein the instructions, when executed by the machine, are to cause the machine further to determine that the JIT instruction specifies, in a fourth location (OP4), a pointer to a memory location to store the machine code.

Example 29 includes the subject matter of Example 24, wherein the instructions, when executed by the machine, are to cause the machine to execute the opcode in XuCode mode.

Example 30 includes the subject matter of Example 24, wherein the instructions, when executed by the machine, are to cause the machine to execute the opcode by inserting a preamble before the opcode and inserting a post amble after the opcode.

Example 31 includes the subject matter of Example 24, wherein the instructions, when executed by the machine, are to cause the machine to utilize a microcode patch referred to as a JIT dispatcher for a determination that the JIT instruction specifies, in a first opcode location (OP1), a file type, the file type including JavaScript files and Web Assembly files; and utilize a microcode patch referred to as a handler for the OP1, to coordinate XuCode execution, responsive to the determination.

Example 32 includes the subject matter of Example 31, wherein the instructions, when executed by the machine, are to cause the machine to update the JIT dispatcher, the library, and the handler during a boot.

Example 33 includes the subject matter of any of Examples 24-32, wherein the apparatus comprises a virtual machine, container, or microservice.

What is claimed is:

1. An apparatus, comprising:
a processor;
a protected system memory;
a just in time (JIT) compiler executable by the processor to:
receive a JIT file comprising instructions;
JIT compile the JIT file into machine code, wherein the machine code includes a translation for the instructions in the JIT file, plus an opcode for a JIT instruction; and
use code stored in the protected system memory to execute the opcode for the JIT instruction while executing the machine code.

2. The apparatus of claim 1, wherein the JIT file is a JavaScript file or a Web Assembly file.

3. The apparatus of claim 1, wherein the JIT instruction is JIT_IT.

4. The apparatus of claim 1, wherein the JIT instruction specifies, in a first opcode location (OP1), a file type, the file type including JavaScript files and Web Assembly files.

5. The apparatus of claim 1, wherein the JIT instruction specifies, in a second opcode location (OP2), a type of optimization, wherein the type of optimization includes performance optimization and power frugality.

6. The apparatus of claim 1, further comprising a memory component having content to compile stored at a memory location, and wherein the JIT instruction, in a third location (OP3), includes a pointer to the memory location.

7. The apparatus of claim 1, further comprising a memory component, and wherein the JIT instruction, in a fourth location (OP4), includes a pointer to a location in the memory component to store the machine code.

8. The apparatus of claim 1, wherein the apparatus comprises a virtual machine, container, or microservice.

9. The apparatus of claim 1, wherein executing the opcode comprises executing in XuCode mode.

10. The apparatus of claim 1, wherein executing the opcode in the protected system memory comprises inserting a preamble before the opcode and inserting a post amble after the opcode.

11. The apparatus of claim 1, wherein the JIT instruction specifies, in a first opcode location (OP1), a file type, the file type including JavaScript files and Web Assembly files, and further comprising:
JIT dispatcher logic to call a XuCode JIT handler for the OP1, responsive to receiving the JIT instruction.

12. The apparatus of claim 11, wherein the XuCode JIT handler comprises a microcode patch, and the JIT compiler is further to update the XuCode JIT handler during a boot.

13. A method comprising:
at a processor,
executing a just in time (JIT) compiler,
updating a library to include a JIT instruction;
receiving a JIT file from an external source, the JIT file comprising instructions;
JIT compiling the JIT file into machine code for the processor, wherein the machine code includes a translation for the instructions in the JIT file, plus an opcode for the JIT instruction; and
executing the opcode for the JIT instruction using code stored in a protected system memory while executing the machine code.

14. The method of claim 13, further comprising:
determining that the JIT instruction specifies, in a first opcode location (OP1), a file type, the file type including JavaScript files and Web Assembly files;
determining that the JIT instruction specifies, in a second opcode location (OP2), a type of optimization, wherein the type of optimization includes performance optimization and power frugality;
determining that the JIT instruction specifies, in a third location (OP3), a pointer to a memory location to retrieve the JIT file; and
determining that the JIT instruction specifies, in a fourth location (OP4), a pointer to a memory location to store the machine code.

15. The method of claim 14, wherein executing the opcode comprises inserting a preamble before the opcode and inserting a post amble after the opcode.

16. The method of claim 14, further comprising utilizing a microcode patch referred to as a JIT dispatcher for a determination that the JIT instruction specifies, in a first opcode location (OP1), a file type, the file type including JavaScript files and Web Assembly files; and utilizing a microcode patch referred to as a handler for the OP1, to coordinate XuCode execution, responsive to the determination.

17. The method of claim 16, further comprising updating the JIT dispatcher, the library, and the handler during a boot.

18. One or more machine readable storage media having instructions stored thereon, the instructions when executed by a machine are to cause the machine to:
update a library in an apparatus to include a just in time (JIT) instruction;
receive a JIT file from a web browser, the JIT file comprising instructions;
JIT compile the JIT file into machine code for the apparatus, wherein the machine code includes a translation for the instructions in the JIT file, plus an opcode for the JIT instruction; and
execute the opcode for the JIT instruction using instructions stored in a protected system memory while executing the machine code.

19. The one or more machine readable storage media of claim 18, wherein the instructions, when executed by the machine, are to cause the machine further to determine that the JIT instruction specifies, in a first opcode location (OP1), a file type, the file type including JavaScript files and Web Assembly files.

20. The one or more machine readable storage media of claim 18, wherein the instructions, when executed by the machine, are to cause the machine further to determine that the JIT instruction specifies, in a second opcode location (OP2), a type of optimization, wherein the type of optimization includes performance optimization and power frugality.

21. The one or more machine readable storage media of claim 18, wherein the instructions, when executed by the machine, are to cause the machine further to determine that the JIT instruction specifies, in a third location (OP3), a pointer to a memory location to retrieve the JIT file.

22. The one or more machine readable storage media of claim 18, wherein the instructions, when executed by the machine, are to cause the machine further to determine that the JIT instruction specifies, in a fourth location (OP4), a pointer to a memory location to store the machine code.

23. The one or more machine readable storage media of claim 18, wherein the instructions, when executed by the machine, are to cause the machine to execute the opcode in XuCode mode.

24. The one or more machine readable storage media of claim 18, wherein the instructions, when executed by the machine, are to cause the machine to utilize a microcode patch referred to as a JIT dispatcher for a determination that the JIT instruction specifies, in a first opcode location (OP1), a file type, the file type including JavaScript files and Web Assembly files; and utilize a microcode patch referred to as a handler for the OP1, to coordinate XuCode execution, responsive to the determination.

25. The one or more machine readable storage media of claim 24, wherein the instructions, when executed by the machine, are to cause the machine to update the JIT dispatcher, the library, and the handler during a boot.
